(19) United States
(12) Patent Application Publication
(10) Pub. No.: US 2026/0001754 A1
(43) Pub. Date: Jan. 1, 2026

(54) SEAT COVER WITH WELDED TIE DOWN STRIPS AND METHOD OF SECURING A SEAT COVER TO A MESH SEAT STRUCTURE

(71) Applicant: LEAR CORPORATION, Southfield, MI (US)

(72) Inventors: Samuel BLAIR, Troy, MI (US); Lisa SWIKOSKI, West Bloomfield, MI (US); David ABDELLA, Royal Oak, MI (US); Joshua HALLOCK, Warren, MI (US)

(73) Assignee: LEAR CORPORATION, Southfield, MI (US)

(21) Appl. No.: 18/879,653

(22) PCT Filed: Jun. 28, 2023
(86) PCT No.: PCT/US2023/026413

§ 371 Date: Dec. 27, 2024

Related U.S. Application Data
(60) Provisional application No. 63/356,310, filed on Jun. 28, 2022.

(30) Foreign Application Priority Data
Jan. 19, 2023 (DK) PA202370029

(51) Int. Cl. B68G 7/052; B60N 2/58

(52) U.S. Cl. CPC B68G 7/052; B60N 2/5866

(57) ABSTRACT

A seat cover secured to a seat structure formed of a mesh body of polymer fibers that are welded together, a method of securing the seat cover having a seam to a novel mesh body seat structure, and fixture used in the method. A mesh pad of welded polymer fibers is covered with the cover including tie down strips is selected. The tie down strips are moved into predetermined locations within the mesh pad, and the mesh pad is heated in the predetermined locations to melt a portion of the polymer fibers onto the tie down strips to hold the tie down strips in the predetermined locations.

### CROSS-REFERENCE TO RELATED APPLICATION

This application claims the benefit of U.S. Provisional Patent Application Ser. No. 63/356,310 filed on Jun. 28, 2022, and Danish Patent Application No. PA202370029 filed on Jan. 19, 2023, the disclosures of both of which are hereby incorporated by reference herein in their entireties.

### TECHNICAL FIELD

The disclosure relates to assembling a seat cover to a polymer mesh seat body by thermally welding tie down strips to the polymer mesh seat structure.

### BRIEF DESCRIPTION OF THE DRAWINGS

FIG. 1 is a diagrammatic front elevation view of a seat structure showing trim seam locations and tie down strip locations.

FIG. 2 is a diagrammatic perspective view of a portion of a tool used to weld tie down strips to a mesh seat structure.

FIG. 3 is a diagrammatic partial perspective view of a gripping tool extended toward a tie down strip having a plastic reinforcement band.

FIG. 4 is a diagrammatic partial perspective view of a gripping tool grasping the tie down strip and moving into a groove in the mesh seat structure.

FIG. 5 is a diagrammatic partial perspective view of a gripping tool holding a tie down strip in a groove in the mesh seat structure while a heating tool welds the tie down strip to the mesh seat structure.

### DETAILED DESCRIPTION

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

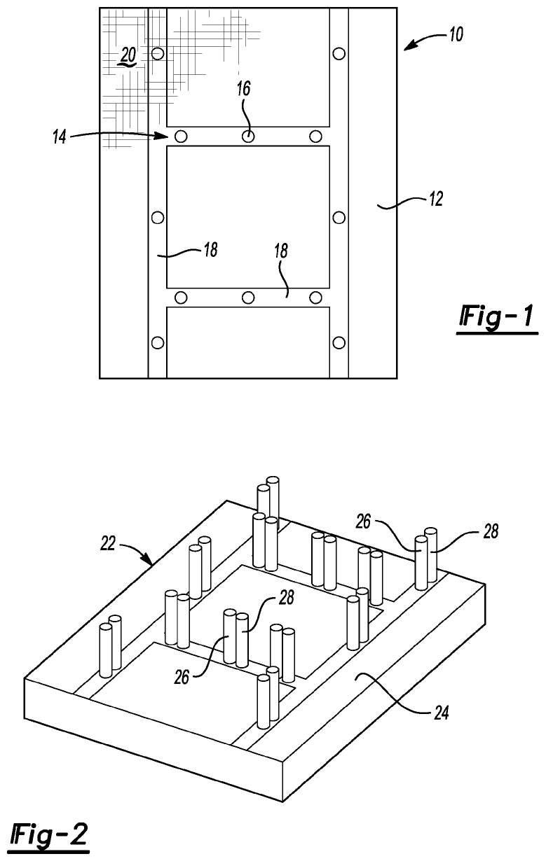

Referring to FIG. 1, part of a seat structure 10 is illustrated that is formed as a mesh web of polyethylene fibers that are welded together and formed into the desired shape of a seat back, seat base, or other type of padded trim part. For brevity, such elements are generally referred to herein as a mesh body 12. As shown in FIG. 1, the mesh body 12 is illustrated with trim seam locations 14 and tie down strip locations 16. The mesh body 12, or mesh pad, defines a plurality of grooves 18 that are provided at the trim seam locations 14 and tie down strip locations 16. The trim seam locations 14 are defined by a seat cover 20.

Referring to FIG. 2, an assembly fixture 22 is illustrated that includes a base 24. The base 24, as illustrated, appears as a plate but the base 24 may be a weldment, a casting, or other type of structure. The assembly fixture 22 includes gripping tools 26 and weld tools 28.

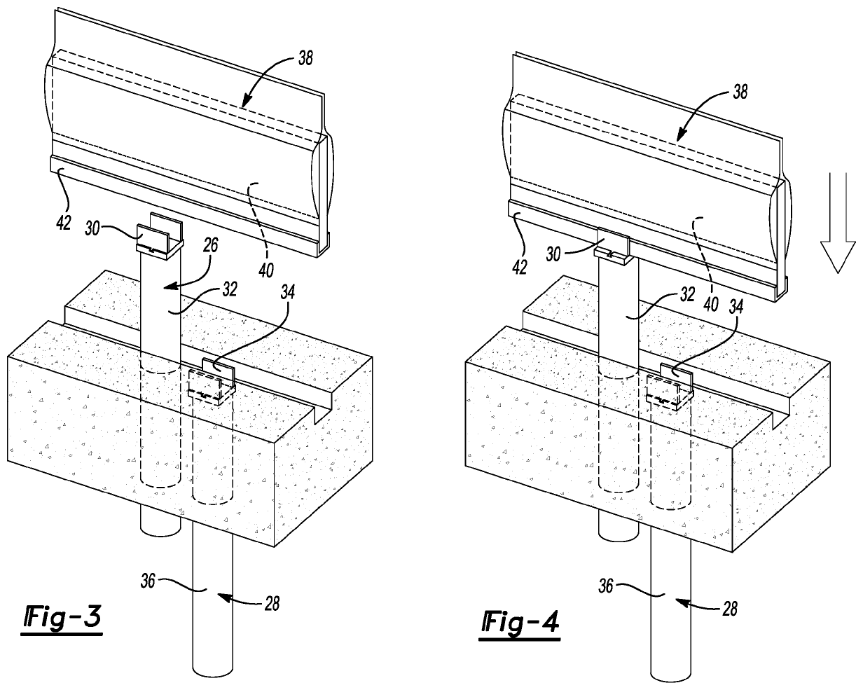

Referring to FIG. 3, a tie down strip 38 is shown in position for the gripping tool 24 to grasp the tie down strip 38. The tie down strip 38 is a strip that includes a plastic reinforcement 42 on an inner edge. The gripping tools 24 include a clamp 30 and a clamp rod 32. The gripping tool has a clamp 30 on its distal end. The clamp may alternatively include a hook, clasp, pincers, or other grasping device that can be used to grasp the tie down strip 38 and the seat cover seam 40 and pull them down into the groove 18 as will be described below.

Referring to FIG. 4, The clamp 30 of the gripping tool 24 is shown to have grasped the tie down strip and is pulling it down as indicated by the arrow on the upper right side thereof as depicted. The weld tool 26 is shown to include a weld tip 34 and a weld rod 36. The weld tip 34 is disposed adjacent the gripping tool 24 with the weld tip 34 disposed in the groove 18. The weld tool 26 remains in the groove 18 and need not extend and retract like the gripping tool 24. The weld tool 26 is pushed through the mesh body 12, grabbing fibers along the way to weld to the tie down.

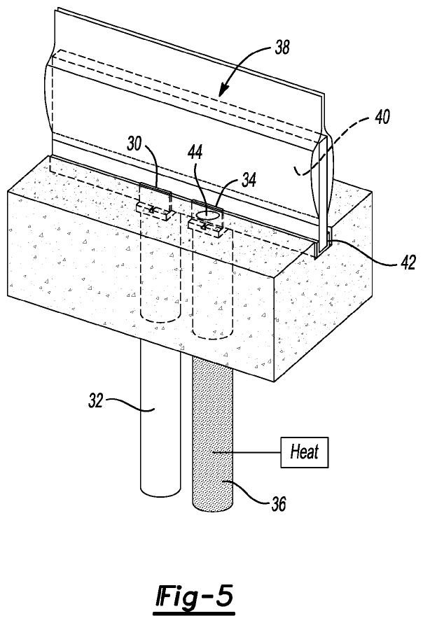

Referring to FIG. 5, the clamp 30 is shown to have pulled the tie down strip 38 and a seat seam 40 attached thereto into the groove 18 where the tie down strip 38 and a reinforcement strip 42 are held in contact with the mesh body 12. While the tie down strip 38 and the reinforcement strip 42 are being held in the groove 18, the weld tip 34 is heated to a temperature sufficient to melt the polyethylene fibers of the mesh body 12 and a portion of the tie down strip 38 and a portion of the reinforcement strip 42. Heat can be provided by heating the rod with a resistance element or by high frequency vibration.

One aspect of this disclosure is a method of securing a seat cover 20 having a seam 40 to a novel mesh body seat structure 12. According to the method, the first step is to select a mesh pad 12 of welded polymer fibers. Next, a cover 20 including tie down strips 38 is selected. The tie down strips 38 are moved into predetermined locations within the mesh pad 12, and the mesh pad 12 is heated in predetermined locations to melt a portion of the polymer fibers onto the tie down strips 38 to hold the tie down strips 38 in the predetermined location.

The disclosed method may be practiced in many different alternative ways and with different materials and steps. For example, the step of forming the mesh pad 12 into the shape of a seat cushion. The sections of flexible material are parts of the seat cover 20 that are sewn together and to the tie down strips 38. The tie down strips 38 are grasped with a gripping tool that moves the tie down strips 38 adjacent to predetermined locations. A heating tool, or welding tool 28 is moved into the mesh pad adjacent to the gripping tool in the predetermined location to melt the polymer fibers onto the tie down strips.

Another aspect of this disclosure is an apparatus comprising a mesh pad 12 of polymer fibers (e.g. polyethylene) bonded together by melted portions of the polymer fibers that is formed into a seat cushion. A seat cover 20 including tie-down strips 38 attached to the seat cover 20 is secured to the mesh pad 38 with welds 44 securing the tie-down strips 38 to the polymer fibers. Seams 40 formed between adjacent sections of flexible cover 20 material are attached to the tie down strips 38. The mesh pad 12 of polymer fibers defines a plurality of grooves 18 recessed into the mesh pad 12. The tie down strips 38 each include a plastic reinforcement strip 42 and a flexible flange 46.

The disclosed apparatus may be practiced in many different alternative ways and with different elements. The mesh pad 12 defines grooves 18 and the seat cover 20 includes the tie down strips 38 that include the flanges 46 of flexible sheet material that are sewn together. The tie down strips 38 are received in the grooves 18 and the welds 44 secure the tie down strips 38 in the grooves 18. The welds 44 are melted polymer fibers held in contact with the tie down strips 38 and cooled to weld the tie down strips 38 to the polymer fibers.

According to yet another aspect of this disclosure a machine 22, or assembly fixture, for assembling a seat cover 20 to a seat structure 10 is disclosed. The machine 22 includes a fixture that receives a mesh pad 12 of polymer fibers bonded together in a form of a seat cushion. The machine 22 includes a grasping tool 26 inserted into the fixture 22 and the mesh pad 12 that grasps a tie down strip 38 that is attached to a seat cover 20 and pulls the tie down strip 38 to a predetermined location in the mesh pad 12. A thermal actuator, or weld tip 34, of a welding tool that melts a portion of the mesh pad onto the tie-down strip to hold the tie-down strip in the predetermined location. The thermal actuator can be a resistance welding tool or a high frequency ultrasonic welding tool.

The disclosed assembly fixture 22 may be practiced in many different alternative ways and with different elements. The fixture 22 includes a plurality of the grasping tools 26 and a plurality of the thermal actuators, or weld tips 34. The grasping tool 26 is in one embodiment is a hook that grasps the tie down strip. The thermal actuator is a pin that is heated by a resistance heating element inside the pin. The tie down strip 34 includes a plastic reinforcement band 42 and a flexible flange 46 that are sewn to an edge of the seat cover 20.

The polymer fibers in one embodiment are thermoplastic polymer fibers.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1-17. (canceled)

18. A method of securing a seat cover to a mesh seat structure comprising:
selecting a mesh pad of polymer fibers;
selecting a cover including tie down strips;
moving the tie down strips into predetermined locations within the mesh pad; and
heating the mesh pad in predetermined locations to melt a portion of the polymer fibers onto the tie down strips to hold the tie down strips in the predetermined location.

19. The method according to claim 1 further comprising:
forming the mesh pad into a seat cushion.

20. The method according to claim 1 further comprising:
sewing sections of flexible material together and to the tie down strips, wherein the cover is a seat cover.

21. The method according to claim 1 further comprising:
grasping the tie down strips with a gripping tool that moves the tie down strip adjacent to the predetermined locations.

22. The method according to claim 4 further comprising:
inserting a heating tool into the mesh pad adjacent to the gripping tool in the predetermined location to melt the polymer fibers onto the tie down strips.

23. An apparatus comprising:
a mesh pad of polymer fibers bonded together by melted portions of the polymer fibers, wherein the mesh pad is formed into a seat cushion;
a seat cover including tie down strips attached to the seat cover; and
welds securing the tie down strips to the polymer fibers.

24. The apparatus according to claim 6 further comprising:
seams formed between adjacent sections of flexible material that are attached to the tie down strips.

25. The apparatus according to claim 6, wherein the mesh pad of the polymer fibers defines a plurality of grooves recessed into the mesh pad.

26. The apparatus according to claim 8, wherein the mesh pad defines grooves, the seat cover includes segments of flexible sheet material that are sewn together with the tie down strips, wherein the tie down strips are received in the grooves and the welds secure the tie down strips in the grooves.

27. The apparatus according to claim 6, wherein the tie down strips each include a plastic reinforcement band and a flexible flange that are sewn to an edge of the seat cover.

28. The apparatus according to claim 6, wherein the welds are melted polymer fibers held in contact with the tie down strips and are cooled to weld the tie down strips to the polymer fibers.

29. The apparatus according to claim 6, wherein the polymer fibers are polyethylene.

30. A machine for assembling a seat cover to a seat structure comprising:
a fixture configured to receive a mesh pad of polymer fibers bonded together in a form of a seat cushion;
at least one grasping tool inserted into the fixture and configured to be inserted in the mesh pad that is configured to grasp a tie down strip that is attached to a seat cover and pulls the tie down strip to a predetermined location in the mesh pad; and
at least one thermal actuator that melts a portion of the mesh pad onto the tie down strip to hold the tie down strip in the predetermined location.

31. The machine according to claim 13, wherein the at least one grasping tool comprises a plurality of the grasping tools and the at least one thermal actuator comprise a plurality of the thermal actuators.

32. The machine according to claim 13, wherein the grasping tool includes a hook that grasps the tie down strip.

33. The machine according to claim 13, wherein the thermal actuator is a pin that is heated by a resistance heating element inside the pin.

34. The machine according to claim 13, wherein the tie down strip includes a plastic reinforcement band and a flexible flange that are sewn to an edge of the seat cover.

35. The machine according to claim 13, wherein the polymer fibers are thermoplastic polymer fibers.
